(19) United States
(12) Patent Application Publication
(10) Pub. No.: US 2007/0263858 A1
(43) Pub. Date: Nov. 15, 2007

(54) USE-YOUR-OWN-HEADSET TELEPHONE

(76) Inventor: Andrei Kemp, Union, NJ (US)

Correspondence Address: ANDREI KEMP, 1179 CARLTON TERRACE, UNION, NJ, 07083-4110, US

(21) Appl. No.: 11/734,602

(22) Filed: Apr. 12, 2007

Related U.S. Application Data
(60) Provisional application No. 60/744,858, filed on Apr. 14, 2006.

(51) Int. Cl. H04M 9/00

(52) U.S. Cl. 379/430

(57) ABSTRACT

A telephone, or modification of an existing telephone allowing users to make or/and receive calls without directly touching the telephone, thereby preventing spread of germs between the users, such as a public telephone, telephone located on a reception desk, lobby, and telephone normally used by one user but with a possibility to be used by another user. Such a telephone would not transfer germs between the users without special sanitizing. Such a telephone, in order to be able being used without direct touch by skin of the user, will be equipped with one or more of jacks, antennas or other type of interface allowing users use of own headset, handset, blue-tooth headset, cellular telephone or any other devise that directly connected (plugged-in) by a wire or connected using a wireless connection allows to make calls through such telephone without using handsets that normally are attached to such telephones.

This is continuation of the same invention filed on-line as a Provisional Patent Application No. 60/744,858 on Apr. 14, 2006

### BACKGROUND OF THE INVENTION

Public telephones, telephones used in receptions, hospitals, offices and other places have handsets or headsets attached and users have to touch them and speak to them. Such telephones are frequently in bad sanitary conditions having surfaces covered with saliva, pieces of foods, drops of drinks etc. which get dry and make the telephone dirty. They may have a bad smell. Such telephones require disinfection and may spread germs. The problem is particularly serious in hospitals where nurses and doctors may transfer germs to others. While inserting coins to slots for coins or payments with magnetic or other card reader etc. does not require direct touching of the phone, talking to a phone requires touching a handset and speaking to a microphone.

In case of receptions or offices, after dialing the number or making a conversation, the handset is frequently given by a receptionist to a visitor, secretary may give it to a manager or nurse may give it to a doctor to transfer conversations creating possibility of transferring germs.

At the same time substantial part of people own and carry audio devices (such as iPods) equipped with headsets, Bluetooth headsets for cellular telephone and cellular telephones that are ready or may allow direct connection to other telephones or be easily modified to allow being use in place of the handset. Also, handset or headsets are inexpensive and small to be carried by anyone who does not have one and wants to have it.

### DESCRIPTION OF THE INVENTION

The invention presents modification of a telephone to allow user use own headset or handset. Such a telephone would allow making a call without direct touching of the telephone. The receptacles and the (electric/electronic) built-in adapters/interfaces between the receptacles and the telephone and the wiring system allow use of any of the headsets/handsets normally used for one or more of popular audio players (such as Walkman, iPod, MP3 player, cellular telephone, Bluetooth etc.) or an inexpensive headset/handset designed purposely to such telephone. In case of such telephone designed for use in hospitals, such a headset/handset could be an integrated with stethoscope normally provided for doctors and nurses.

Establishing connection (or communication) between the headset/handset (by plugging headset/handset into one of the receptacles or activating wireless communication between the transceiver in the wireless headset/handset and the compatible transceiver built into such telephone by pressing an activation key) would result in the same response as lifting the handset normally attached to the telephone, i.e. activation of the dial tone and withdrawing (breaking wireless communication) would result the same response as putting up the handset normally attached to the telephone. All other operation (such as response to drop of the coin into the coin slot) would be as at currently operating telephones. Dispensing of finger protectors, sticks and/or sanitizing elements is optional and may be controlled by inserting the coin or establishing communication between the headset/handset and such a telephone, by pressing a button or by a sensor or similar device.

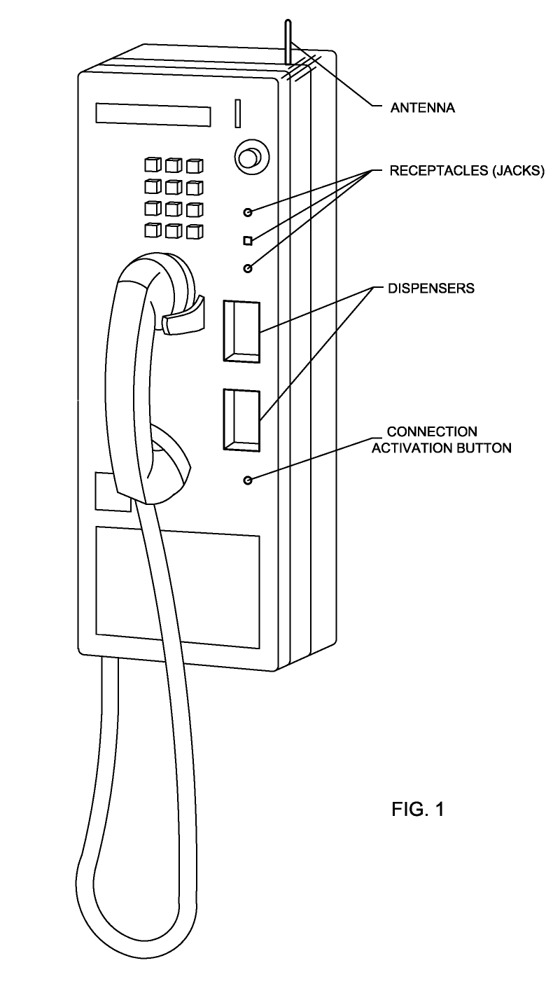

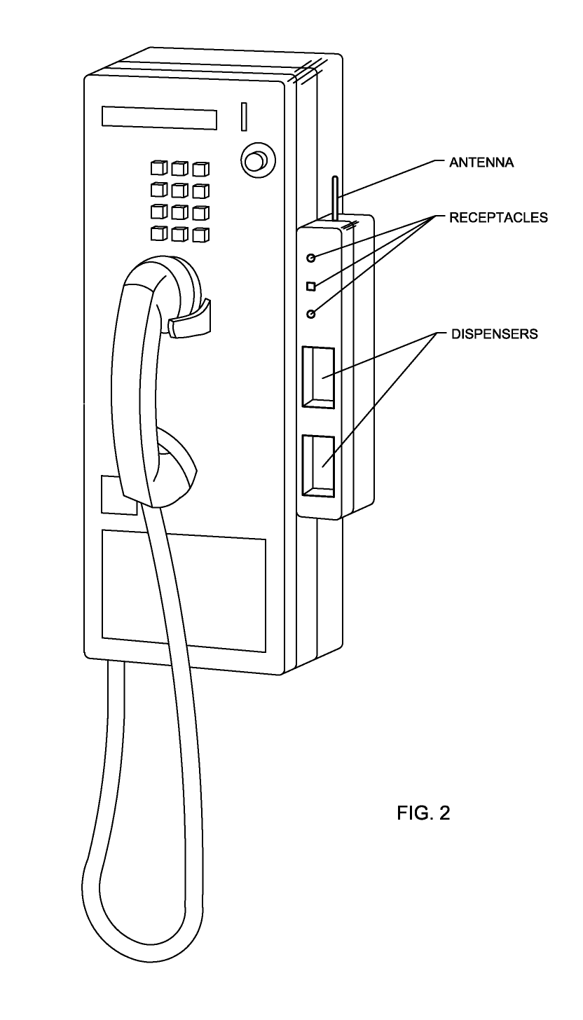

FIG. 1 shows a typical public payphone modified for such operation. FIG. 2 shows an optional modification will the receptacles, dispensers, antenna(s), activation key and the electric/electronic circuits placed in a separate box attached and connected to the telephone.

The drawing shown the invention as a modification of a public, wall mounted payphone and gives the idea how other types of phones (such as desk type used in offices) will have to be modified.

It is to be understood that the methods and apparatus, which have been described above and shown on the drawings are only illustration for applications of the principles of the invention. Numerous modifications may be made by those skilled in the area without departing from the true spirit and scope of the invention.

This substitute specification contains no new matter and the only difference is the claims have been deleted and the text line spacing that has been changed from single to 1%.

Establishing connection (or communication) between the headset/handset (by plugging headset/handset into one of the receptacles or activating wireless communication between the transceiver in the wireless headset/handset and the compatible transceiver built into such telephone by pressing an activation key) would result in the same response as lifting the handset normally attached to the telephone, i.e. activation of the dial tone and withdrawing (breaking wireless communication) would result the same response as puffing up the handset normally attached to the telephone. All other operation (such as response to drop of the coin into the coin slot) would be as at currently operating telephones. Dispensing of finger protectors, sticks and/or sanitizing elements is optional and may be controlled by inserting the coin or establishing communication between the headset/handset and such a telephone, by pressing a button or by a sensor or similar device.

FIG. 1 shows a typical public payphone modified for such operation. FIG. 2 shows an optional modification will the receptacles, dispensers, antenna(s), activation key and the electric/electronic circuits placed in a separate box attached and connected to the telephone.

The drawing shown the invention as a modification of a public, wall mounted payphone and gives the idea how other types of phones (such as desk type used in offices) will have to be modified.

It is to be understood that the methods and apparatus, which have been described above and shown on the drawings are only illustration for applications of the principles of the invention. Numerous modifications may be made by those skilled in the area without departing from the true spirit and scope of the invention.

1. A telephone, or modification of an existing telephone such as a public telephone, telephone located on a reception desk, lobby, and telephone normally used by one user but with a possibility to be used by another user, for sanitary purposed (avoiding transfer of germs between users) modified to allow users make calls without using handsets that normally are attached to such telephones.

2. A telephone as described in claim 1, in order to be able being used without direct touch by skin of the user equipped with one or more of jacks, antennas or other type of interface allowing users use of own headset, handset, blue-tooth headset, cellular telephone or any other device that directly connected (plugged-in) by a wire or directly connected using a wireless connection to such telephone allows make a call through such telephone without handsets that normally are attached to telephones.

3. A box, container or similar device equipped with one or more of jacks, antennas or other type of interface allowing users use of own headset, handset, blue-tooth headset, cellular telephone that can be attached, plugged in or wirelessly connected to a telephone in order to allow users use of own headset, handset, blue-tooth headset, cellular telephone or any other device that directly connected (plugged-in) by a wire or directly connected using a wireless connection to such telephone allows make a call through such telephone without handsets that normally are attached to such telephones.

4. A telephone as described in claim I equipped with one or more jacks (receptacles), antennas or other ports with interconnecting electronic/electric devices to allow use of the user-own-headset/handset (not normally connected to such telephone) to be used with such telephone;

5. A telephone as described in claim 1 having one or more built-in transceivers to provide wireless link (wireless connection) between such telephone and an user own headset/handset (such as a short-range radio Bluetooth transceiver, infrared, ultrasound or other wireless communication device) which provides communication with compatible transceiver in such telephone and with interconnecting electronic/electric devices allowing communication between such transceivers and the telephone.

6. A telephone as described in claim 1 having a button, key, switch or other device that allows activation of a wireless connection (communication) between such telephone and wireless handset/headset for the purpose of making a call through such telephone without handsets that normally are attached to telephones.

7. A telephone as described in claim 1 having one or more dispensers of finger protectors, small plastic or wooden sticks, or any similar elements to allow user to press dial keys (buttons) on the telephone without direct touching of the buttons with finger.

8. A stethoscope, head cover or other equipment normally used by a professional person with attached or built-in headset, handset, blue-tooth headset, or any other device that directly connected (plugged-in) by a wire or directly connected using a wireless connection to such a telephone as described in claim 1 allows make a call through such telephone without handsets that normally are attached to telephones.
